(19) United States
(12) Patent Application Publication
(10) Pub. No.: US 2024/0378779 A1
(43) Pub. Date: Nov. 14, 2024

(54) EFFECT EDITING METHOD, APPARATUS, ELECTRONIC DEVICE, AND STORAGE MEDIUM

(71) Applicants: BEIJING ZITIAO NETWORK TECHNOLOGY CO., LTD., Haidian District (CN); Lemon Inc., Grand Cayman (KY)

(72) Inventors: Siyu SHEN, Beijing (CN); Siran LIAO, Beijing (CN); Shu LIU, Beijing (CN); Gao LIU, Beijing (CN); Yeqi ZHANG, Beijing (CN)

(21) Appl. No.: 18/657,396

(22) Filed: May 7, 2024

(30) Foreign Application Priority Data
May 8, 2023 (CN) 202310513091.8

(51) Int. Cl. G06T 11/60; G11B 27/031

(52) U.S. Cl. CPC G06T 11/60; G11B 27/031

(57) ABSTRACT

Embodiments of the present disclosure provide an effect editing method and apparatus, an electronic device, and a storage medium. The method includes: in response to an interface display triggering operation for an effect processing image, displaying an effect editing interface, and displaying, in the effect editing interface, at least one element identifier of at least one effect element that has been added in the effect processing image; in response to an identification selection triggering operation for the at least one element identifier, identifying an effect element corresponding to a selected element identifier as an element to be edited; and in response to an apply-mode-editing triggering operation for the element to be edited, determining a target applying mode that the element to be edited is applied to the effect processing image.

### CROSS-REFERENCE TO RELATED APPLICATION

The present application claims priority of Chinese Patent Application No. 202310513091.8, filed on May 8, 2023, and the entire content disclosed by the Chinese patent application is incorporated herein by reference as part of the present application for all purposes under the U.S. laws.

### TECHNICAL FIELD

Embodiments of the present disclosure relate to the technical field of human-computer interaction, and in particular, to an effect editing method and apparatus, an electronic device, and a storage medium.

### BACKGROUND

In image processing or video production scenarios, the application of effect props is particularly favored by users. The effect props may be made for use by an effect creation tool, which often comprises a lot of information used to create the effect props, for example, information used to edit the manner in which the effect props are applied to images or videos.

In the related art, effects are often edited by editing the corresponding action pattern of each effect prop in advance at the product development stage. Further, the edited contents are packaged in a software development kit and stored in the database of the effect creation tool in correspondence with the effect prop, and when a user edits any effect prop based on the effect creation tool, the corresponding software development kit is directly invoked.

However, the user's inability to modify the editing parameters packaged in the software development kit results in the effect display effect based on the effect image or the effect video produced by the effect prop being relatively simple, not satisfying the user's personalized editing needs for the effect prop, and having certain limitations that affect the user's effect production experience.

### SUMMARY

The present disclosure provides an effect editing method and apparatus, an electronic device, and a storage medium to enable a user to customize and edit the manner an effect element acts on an effect image.

In a first aspect, an embodiment of the present disclosure provides an effect editing method, and the method comprises:
in response to an interface display triggering operation for an effect processing image, displaying an effect editing interface, and displaying, in the effect editing interface, at least one element identifier of at least one effect element that has been added in the effect processing image;
in response to an identification selection triggering operation for the at least one element identifier, identifying an effect element corresponding to a selected element identifier as an element to be edited;
in response to an apply-mode-editing triggering operation for the element to be edited, determining a target applying mode that the element to be edited is applied to the effect processing image.

In a second aspect, an embodiment of the present disclosure further provides an effect editing apparatus, and the apparatus comprises:
an editing interface display module configured to, in response to an interface display triggering operation for an effect processing image, display an effect editing interface, and display, in the effect editing interface, at least one element identifier of at least one effect element that has been added in the effect processing image;
an effect element selection module configured to, in response to an identification selection triggering operation for the at least one element identifier, identify an effect element corresponding to a selected element identifier as an element to be edited;
an applying mode determination module configured to, in response to an apply-mode-editing triggering operation for the element to be edited, determine a target applying mode that the element to be edited is applied to the effect processing image.

In a third aspect, an embodiment of the present disclosure further provides an electronic device, and the electronic device comprises: one or more processors; a storage apparatus for storing one or more programs, the one or more programs, when executed by the one or more processors, cause the one or more processors to implement the effect editing method according to any one of the embodiments of the present disclosure.

In a fourth aspect, an embodiment of the present disclosure further provides a non-transitory computer-readable storage medium comprising computer-executable instructions, and the computer-executable instructions, when executed by a computer processor, are used to perform the effect editing method as described in any one of the embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. Throughout the accompanying drawings, the same or similar reference numerals indicate the same or similar elements. It should be understood that the accompanying drawings are schematic and that components and elements are not necessarily drawn to scale.

FIG. 1 is a schematic flowchart of an effect editing method according to an embodiment of the present disclosure;

FIG. 2 is a schematic diagram of an effect editing interface provided by an embodiment of the present disclosure;

FIG. 3 is a schematic flowchart of another effect editing method according to an embodiment of the present disclosure;

FIG. 4 is a schematic flowchart of another effect editing method according to an embodiment of the present disclosure;

FIG. 5 is a schematic diagram of an effect element editing unit according to an embodiment of the present disclosure;

FIG. 6 is a schematic diagram of an effect editing interface provided by an embodiment of the present disclosure;

FIG. 7 is a schematic flowchart of another effect editing method according to an embodiment of the present disclosure;

FIG. 8 is a structural schematic diagram of an effect editing apparatus according to an embodiment of the present disclosure; and

FIG. 9 is a structural schematic diagram of an electronic device according to an embodiment of the present disclosure.

### DETAILED DESCRIPTION

Embodiments of the present disclosure will be described in more detail below with reference to the accompanying drawings. Although certain embodiments of the present disclosure are illustrated in the accompanying drawings, it should be understood that the present disclosure may be embodied in various forms and should not be construed as being limited to the embodiments set forth herein. On the contrary, these embodiments are provided for a more thorough and complete understanding of the present disclosure. It should be understood that the drawings and embodiments of the present disclosure are for exemplary purposes only and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or omit performing the steps shown. The scope of the present disclosure is not limited in this aspect.

The term “comprise/include” and variations thereof used in this article are open-ended inclusion, namely “comprise/include but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules, or units, and are not intended to limit orders or interdependence relationships of functions performed by these apparatuses, modules, or units.

It should be noted that the modifications of “a”, “a plurality” mentioned in the present disclosure are illustrative rather than limiting, and those skilled in the art should understand that it should be understood as “one or more” unless otherwise explicitly stated in the context.

The names of messages or information interacted between a plurality of devices in the embodiments of the present disclosure are used for illustrative purposes only and are not used to limit the scope of such messages or information.

It can be understood that before using the technical solution disclosed by the embodiments of the present disclosure, the user should be informed of the type, the use range, the use scenario, and the like of the personal information to which the present disclosure relates and obtain the authorization of the user in an appropriate manner in accordance with the relevant laws and regulations.

For example, in response to receiving an active request from a user, prompt information is sent to the user to explicitly prompt the user that the operation that he/she requests to perform will require acquisition and use of personal information of the user. Thus, it is possible for the user to autonomously select whether to provide personal information to software or hardware such as an electronic device, an application program, a server, or a storage medium, which performs the operations of the technical solution of the present disclosure, according to the prompt information.

As an alternative but non-limiting implementation, the manner in which the prompt information is sent to the user in response to receiving the active request from the user may be, for example, in the form of a pop-up window in which the prompt information may be presented in the form of text. In addition, the pop-up window may also comprise an option for the user to choose to “agree” or “disagree” to provide personal information to the electronic device.

It is to be understood that the above-described process of notification and obtaining user authorization is merely illustrative and does not constitute a limitation to implementations of the present disclosure, and that other ways of satisfying the relevant laws and regulations may also be applied to implementations of the present disclosure.

It will be appreciated that the data to which the present solution relates, including but not limited to the data itself, the acquisition or use of the data, should comply with the requirements of the corresponding laws and regulations and related regulations.

Before introducing the present technical solution, the application scenario may be exemplarily explained first. The technical solution may be applied to a scenario in which the mode of applying the effect element to the effect processing image is edited on the premise of determining the effect element that has been added in the effect processing image. Exemplarily, after determining the effect element that has been added in the effect processing image, the element to be edited may be determined upon detecting the identification selection triggering operation for the element identifier of the effect element, and further, the target applying mode of the element to be edited being applied to the effect processing image may be determined, the existing effect editing modes all directly invoke a pre-packaged software development tool kit and take the applying mode included in the invoked software development tool kit as the target applying mode, the user cannot modify the editing parameters encapsulated in the software development tool kit. As a result, the effect display effect based on the effect image or effect video produced by the effect props is relatively simple, which cannot satisfy the user's personalized editing needs for the effect props and has certain limitations. In this case, based on the technical solution of the embodiments of the present disclosure, the user can input the apply-mode-editing triggering operation with respect to the element to be edited, and in turn, the target applying mode of the element to be edited being applied to the effect processing image can be determined according to the apply-mode-editing triggering operation input by the user, so that the effect of custom editing of the applying mode in which the effect element is applied to the effect image by the user is achieved, the flexibility of editing the effect element is increased, and the use experience of the effect creation tool by the user is improved.

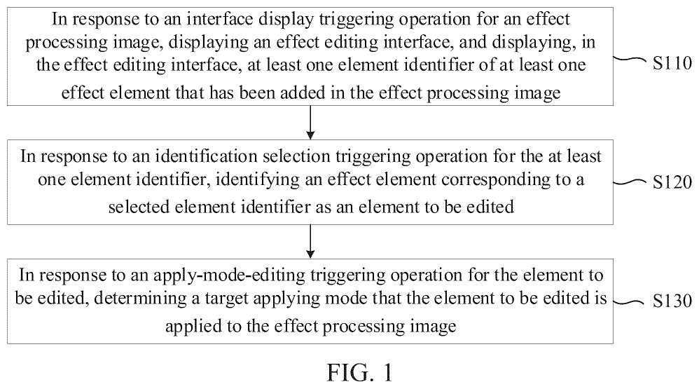

FIG. 1 is a flowchart diagram of an effect editing method according to an embodiment of the present disclosure, the embodiments of the present disclosure is applicable to the case of editing the manner of applying an effect element to an effect processing image on the premise of determining the effect element that has been added in the effect processing image, the effect editing method may be performed by an effect editing apparatus, which may be implemented in the form of software and/or hardware, and optionally, implemented by an electronic device, and the electronic device may be a mobile terminal, a PC terminal, a server, or the like.

As shown in FIG. 1, the method of the present embodiment specifically may include:

S110, in response to an interface display triggering operation for an effect processing image, displaying an effect editing interface, and displaying, in the effect editing interface, at least one element identifier of at least one effect element that has been added in the effect processing image.

Here, the apparatus for performing the effect editing method provided by the embodiments of the present disclosure may be integrated in an application software supporting the effect element editing function, and the software may be installed in an electronic device, and alternatively, the electronic device may be a mobile terminal or a PC terminal or the like. The application software may be a kind of software that edits the effect element added to the image, and its specific application software will not be described in detail here, as long as the effect element editing can be achieved. The application software may also be a specially developed application, and is integrated in the software for implementing the editing of the effect elements, or integrated in a corresponding page, and the user may implement the editing of the effect elements through the page integrated in the PC terminal.

In the present embodiment, the effect processing image may be an image to which an effect element is added. Alternatively, the effect processing image may be an image pre-stored by the application software in a storage space, an image transmitted by an external device, an image obtained by adding an effect element to the original image after the original image to be processed is captured in real time based on the terminal device, or the like. The effect element may be an effect prop added to the image or video to cause the image or video to present an effect display effect. It should be noted that the number of the effect element(s) added to the effect processing image may be one or more, and that the effect elements added to the effect processing image include effect elements that are displayed in the display interface and also include effect elements that are not displayed in the display interface.

In this embodiment, a control for triggering the display of the effect editing interface may be developed in advance, or a piece of program code for triggering the display of the effect editing interface may be set in advance. When it is detected that the user triggers the control or the program code is received during the application process, the effect editing interface may be displayed in response to the interface display triggering operation. The control for triggering the display of the interface may be any form of control. Optionally, the control for triggering the display of the interface may be a “Behavior” control. Yet another implementation may be that the effect elements added in the effect processing image may be set to an editable state in advance, and when a click operation for any effect element added in the effect processing image is detected, the effect editing interface may be displayed in response to the click operation. Optionally, the click operation may be a single click operation or a multiple click operation (e.g., a double-click operation, etc.). In order to facilitate the user's operation, yet another implementation may be to jump to the effect editing interface when it is detected that a duration of a pause of the user on any effect element added in the effect processing image based on the input device or the touch point reaches a preset duration.

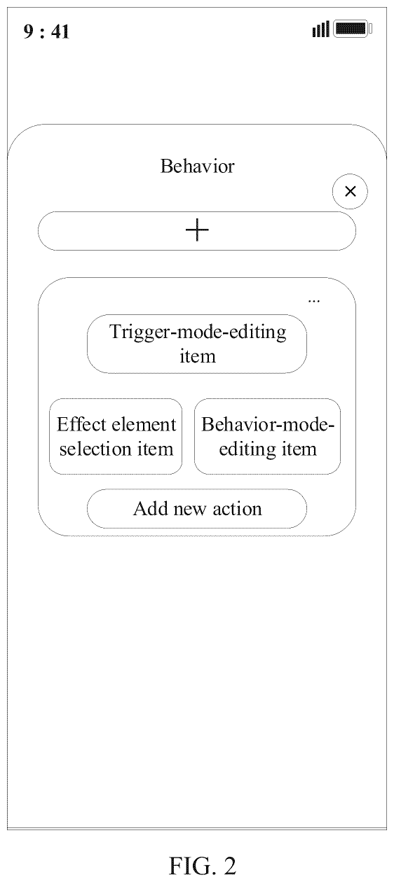

In the embodiment, the effect editing interface may be an interface for editing all effect elements added to the effect processing image. At least one effect editing item for editing the effect element may be included in the effect editing interface. Optionally, an effect element selection item, an apply-mode-editing item, and the like may be included in the effect editing interface. The effect element selection item may be a trigger control for displaying the effect element added in the effect processing image. The apply-mode-editing item includes a trigger-mode-editing item and a behavior-mode-editing item. The behavior-mode-editing item may be a control for editing an effect applying mode the effect element acts on the effect processing image. The trigger-mode-editing item may be a control that edits the effect triggering mode of the effect element. Illustratively, as shown in FIG. 2, which is a schematic diagram of an effect editing interface, it can be seen that the effect editing interface includes an effect element selection item, a trigger-mode-editing item, and a behavior-mode-editing item.

In practical applications, the effect processing image may be first acquired and presented in the display interface of the terminal device, when an interface display triggering operation for the effect processing image is detected, an effect editing interface may be displayed in response to the operation, and the element identifier of the effect element that has been added in the effect processing image is displayed in the effect editing interface. Optionally, the element identifier may be a thumbnail of the effect element, and/or an effect element name, or the like. For example, if the effect element is a hat, the corresponding element identifier may be a thumbnail of the hat and text “Hat”; and if the effect element is eyeglasses, the corresponding element identifier may be a thumbnail of the eyeglasses and text “Glass”.

In the present embodiment, displaying the element identifier of the effect element that has been added in the effect processing image in the effect editing interface may include at least one implementation, which may be described below.

Optionally, an effect element selection item may be included in the effect editing interface. Displaying the element identifier of the effect element that has been added in the effect processing image in the effect editing interface may include: displaying, in the effect editing interface, the at least one element identifier of the at least one effect element that has been added in the effect processing image in response to an element selection triggering operation acting on the effect element selection item.

In the present embodiment, the effect element selection item may be a control for filtering out the effect elements that have been added in the effect processing image from the effect processing image.

In the actual application process, the element selection triggering operation applied on the effect element selection item may be any operation on the effect element selection item, for example, a click operation for the effect element selection item. The click operation may be a single click operation or a multi-click operation (e.g., a double-click operation, etc.). For the convenience of the user, when it is detected that the duration of the user's pause on the effect element selection item based on the input device or the touch point reaches a preset duration, the operation of the user at this time can be used as the element selection triggering operation on the effect element selection item and the operation can be responded to.

In an implementation, an effect editing interface may be displayed in response to the interface display triggering operation when detecting the interface display triggering operation for the effect processing image. In the effect editing interface, an effect element selection item is presented. Further, when an element selection triggering operation acting on the effect element selection item is detected, the element identifier of the effect element that have been added in the effect processing image may be displayed in the effect editing interface in response to the element selection triggering operation. The advantage of such setting is that the effect of filtering out all the effect elements added in the effect processing image from the effect processing image and displaying the element identifiers corresponding to the effect elements is implemented, and at the same time, the effect of correspondingly editing the effect elements added in the effect processing image is achieved.

Note that the element identifiers of the effect elements displayed in the effect editing interface are the element identifiers of all the effect elements added in the effect processing image, including the element identifiers of the effect elements hidden from the effect processing image, and the element identifiers of the effect elements displayed on the effect processing image.

S120, in response to an identification selection triggering operation for the at least one element identifier, identifying an effect element corresponding to a selected element identifier as an element to be edited.

In the present embodiment, each element identifier may be set to be in a selectable state in advance, and further, in the case where the element identifier is a selected element identifier, the element identifier is subjected to subsequent processing.

The selected element identifier may be an element identifier selected from the at least one element identifier according to the identification selection triggering operation.

In a practical application, the identification selection triggering operation for the element identifier may be any operation performed on the at least one element identifier, for example, a click operation for an element identifier, specifically, when it is detected that a user inputs a click operation on an element identifier of an effect element displayed in the effect editing interface through an input device or a touch point, the element identifier, on which the click operation is performed, may be regarded as a selected element identifier, and then subsequent processing is performed on the element identifier. Here, the click operation may be a single click operation or a multi-click operation (e.g., a double-click operation, etc.). In order to facilitate the user's operation, the identification selection triggering operation for the element identifier may be that: when it is detected that the duration of the user's pause on the element identifier based on the input device or the touch point reaches a preset duration, the element identifier may be regarded as the selected element identifier, and the selected element identifier may be subsequently processed.

In a specific implementation, after the element identifiers of the effect elements that have been added in the effect processing image are displayed in the effect editing interface, the user may select among the element identifiers displayed in the effect editing interface. When detecting an identification selection triggering operation for an element identifier that is input by the user via the input device or the touch point, the element identifier may be taken as a selected element identifier in response to the identification selection triggering operation, the effect element corresponding to the selected element identifier may be determined, and the effect element may be identified as the element to be edited. The element to be edited may be an effect element on which effect editing needs to be performed.

It should be noted that the number of the selected element identifier(s) may be one or more, that is, the number of element(s) to be edited may be one or more. If the number of element(s) to be edited is one, a single effect editing may be performed on the one element to be edited; and if the number of elements to be edited is more than one, a combined effect editing and/or a single effect editing may be performed on the more than one element to be edited.

S130, in response to an apply-mode-editing triggering operation for the element to be edited, determining a target applying mode that the element to be edited is applied to the effect processing image.

In the present embodiment, after the element to be edited is determined, apply-mode editing may be performed with respect to the element to be edited, thereby determining a target applying mode the element to be edited is applied to the effect processing image.

In this embodiment, the apply-mode-editing control may be developed in the effect editing interface in advance and displayed in association with the element to be edited. When a triggering operation on the editing control by a user is detected, the triggering operation may be used as a apply-mode-editing triggering operation for the element to be edited, and then the target applying mode of the element to be edited on the effect processing image may be determined in response to the triggering operation.

In the above embodiment, the target applying mode may be a mode in which the effect of the element to be edited is displayed in the effect processing image. In this embodiment, the target applying mode may include an effect triggering mode and/or an effect behavior mode. The effect triggering mode may be a mode of triggering to display the effect of the element to be edited in the effect processing image. The effect behavior mode may be a mode in which the effect of the element to be edited is displayed in the effect processing image.

It is to be noted that the target applying mode corresponding to a single element to be edited includes at least one selected from a group comprising: a dynamic display mode of an element display parameter of the effect element, an association mode of the effect element with respect to an image subject associated with the effect element in the effect processing image, and a behavior mode of the effect element. Among them, the element display parameter of the effect element may be a parameter that characterizes an effect display of the effect element in the image. Element display parameters may include any parameters, for example, a display position, a display size, display transparency, display intensity, and the like. The dynamic display mode may be a mode in which the effect element is dynamically displayed in the effect processing image based on the corresponding element display parameter. The association mode of the effect element with respect to the image subject associated with the effect element in the effect processing image may be a mode through which the effect element is associated with the image subject included in the effect processing image when the effect element is displayed in the effect processing image. For example, if the effect type of the element to be edited is a sticker effect, a facial effect, and a liquefaction effect, the association mode may be that the abscissa of the effect element is aligned with the image subject. If the effect type of the element to be edited is a filter effect, a make-up effect, and a deformation effect, the association mode may be controlled by the abscissa of any effect element. The behavior mode of the effect element may be a behavior mode in which the effect element is applied to the effect processing image. For example, if the effect type of the element to be edited is a sticker effect, a facial effect, and a liquefaction effect, the behavior mode of the effect element may include: appearing animation, emphasizing animation, disappearing animation, switching and customizing animation, and the like. If the effect type of the element to be edited is a filter effect, a make-up effect, and a deformation effect, the behavior mode of the effect element may be: appearing or gradually appearing (fade into), disappearing or gradually disappearing (fade out), switching, and the like.

The target applying modes respectively corresponding to a plurality of elements to be edited may include a common applying mode shared by the plurality of elements to be edited and/or a combined display mode of the plurality of elements to be edited. The combined display mode may be associated with a display order and/or a switching mode of each of the plurality of elements to be edited. It should be understood that the plurality of elements to be edited may be displayed simultaneously or one by one.

In the actual application process, all the effect elements that can be added to the original image to obtain the effect processing image can be predetermined, and the effect elements are classified according to their corresponding effect types. Further, the applying mode corresponding to the effect element of each effect type can be preset, the applying mode is associated with the effect type, and the applying modes are stored in the database of the terminal device, so that when the element to be edited is determined, and the apply-mode-editing triggering operation for the element to be edited is detected, the effect type of the element to be edited can be determined, and then the corresponding applying mode is invoked from the database according to the effect type, and the invoked applying mode is displayed on the effect editing interface. Further, the user can select among the applying modes displayed on the effect editing interface by a triggering operation. When the user's triggering operation on any applying mode is detected, the detected applying mode can be used as the target applying mode for the element to be edited to act on the effect processing image.

The technical solution of the embodiments of the present disclosure, by displaying an effect editing interface in response to an interface display triggering operation for an effect processing image and displaying, in the effect editing interface, an element identifier of an effect element that has been added in the effect processing image, can accurately capture the user's editing intention for the effect element, display an editable effect element, and provide an interactive portal for the user; and further, the technical solution of the embodiments of the present disclosure, by in response to an identification selection triggering operation for the element identifier, taking an effect element corresponding to a selected element identifier as an element to be edited, supports the flexible editing of the effect element by the user, supports diverse editing methods, and enriches the editing effect of the effect element, and finally, a target applying mode of the element to be edited to apply to the effect processing image is determined in response to an apply-mode-editing triggering operation for the element to be edited. Thus, the technical solution of the embodiments of the present disclosure solves the problem in the prior art, which is due to the fact that the user cannot modify the editing parameters encapsulated in the software development tool kit, and thus an effect display effect of the effect image or the effect video produced based on the effect prop is relatively simple, which cannot satisfy the user's personalized editing needs for the effect prop. It enables the user to customize the editing of the mode of applying the effect element to the effect image, increases the flexibility of editing the effect element, and improves the user's experience in using the effect production tool.

FIG. 3 is a schematic flowchart of another effect editing method according to an embodiment of the present disclosure. On the basis of the above embodiment, in technical solution of the present embodiment, the effect editing interface includes an apply-mode-editing item corresponding to the element to be edited, and further, the target applying mode of the element to be edited applied to the effect processing image can be determined in response to the triggering operation for the apply-mode-editing item. For specific implementation details, reference may be made to the description of the present embodiment. In the description, the technical features that are the same or similar to those in the foregoing embodiments are not repeated herein.

As shown in FIG. 3, the method of the present embodiment may include:

S210, in response to an interface display triggering operation for an effect processing image, displaying an effect editing interface, and displaying, in the effect editing interface, at least one element identifier of at least one effect element that has been added in the effect processing image;

S220, in response to an identification selection triggering operation for the at least one element identifier, identifying an effect element corresponding to a selected element identifier as an element to be edited; and

S230, in response to a mode display triggering operation for the apply-mode-editing item, displaying at least one candidate applying mode corresponding to the element to be edited.

In the present embodiment, the apply-mode-editing item may be a control for editing the mode of applying the effect element to the effect processing image. The apply-mode-editing item may be displayed in the effect editing interface and associated with the element to be edited. Generally, the mode of applying the effect element to the effect processing image may include an effect triggering mode and an effect behavior mode (i.e., after triggering, the effect behavior to which the effect element corresponds in the effect processing image), and accordingly, the apply-mode-editing item may include a trigger-mode-editing item and/or a behavior-mode-editing item.

Optionally, the apply-mode-editing item includes a behavior-mode-editing item, and the behavior-mode-editing item is used for editing a target behavior mode of the element to be edited when displayed on the effect processing image. The target behavior mode may be a mode to which the element to be edited corresponds, when the effect of the element to be edited is displayed in the effect processing image. In the present embodiment, the target behavior mode may include a frequently-used behavior mode, an appearing animation, a disappearing animation, a process animation, and the like. For example, the frequently-used behavior mode may include appearing, disappearing, or switching. The appearing animation may include appearing directly or appearing in other ways, and etc. The disappearing animation may include directly disappearing or disappearing in other ways, and etc. The process animation may include an intensity animation or a transparency animation, etc. The advantage of such setting is that the user can perform personalized editing on the target behavior mode of the effect element displayed in the effect processing image, which can satisfy the user's needs for personalized customization of the corresponding effect props and improves the user experience.

Optionally, the apply-mode-editing item may further include a trigger-mode-editing item, and the trigger-mode-editing item is used for editing a target trigger mode of the element to be edited for being displayed on the effect processing image. The target trigger mode may be a mode of triggering the element to be edited to be applied to the effect processing image. In the present embodiment, the target trigger mode may include a trigger-type mode and a state-type mode. The trigger-type mode may be used to determine whether to trigger the element to be edited to act on the effect processing image by detecting whether a certain behavior occurs. Optionally, the trigger type also includes general trigger, facial feature trigger, expression trigger, gesture trigger, and the like. Exemplary, the general trigger may include clicking on a screen or the like. The facial feature trigger may include blinking, nodding, waving hand, opening the mouth, raising the eyebrows, and the like. The expression trigger may include happy expressions, feared expressions, sad expressions, surprised expressions, and angry expressions, among others. The gesture trigger may include opening palm, holding fist, at least one finger pointing upward, and salute gesture, among others. The state-type mode may be used to determine whether to trigger the element to be edited to be applied to the effect processing image by detecting whether the duration of a certain state reaches a preset duration. The preset duration may be any duration, and for example, may be 3 seconds, 4 seconds, 5 seconds, or the like. Optionally, the state type may include a general state, a facial feature state, an expression state, a gesture state, and the like. For example, the general state may be that the duration of pressing on the screen reaches 3-5 seconds. The facial feature state may include a mouth-open state lasting up to 3-5 seconds, or a hand-waving state lasting up to 3-5 seconds. The expression state may include that the duration of an expression reaches 3-5 seconds, and the expression comprises, such as, a happy expression, a feared expression, a sad expression, a surprised expression, and an angry expression. The gesture state may include that the duration of the gesture reaches 3-5 seconds, and the gesture comprises, such as, opening palm, holding fist, at least one finger pointing upward, and salute gesture. The advantage of such setting is that the user can perform personalized editing on the target trigger mode of the effect element for being displayed in the effect processing image, which satisfies the user's needs for personalized customization of the corresponding effect props and improves the user experience.

In the above embodiment, the candidate applying mode may be an applying mode that matches the effect type of the element to be edited, and the applying mode is selected from preset applying modes. The candidate applying mode may include a candidate trigger mode and/or a candidate behavior mode.

In practical application, the mode display triggering operation for the apply-mode-editing item may include a mode display triggering operation for the trigger-mode-editing item only, a mode display triggering operation for the behavior-mode-editing item only, and a mode display triggering operation for the trigger-mode-editing item and the behavior-mode-editing item. Specifically, when the mode display triggering operation for the trigger-mode-editing item is detected, preset candidate trigger modes may be displayed on the effect editing interface. When the mode display triggering operation for the behavior-mode-editing item is detected, preset candidate behavior modes may be displayed on the effect editing interface. When the mode display triggering operation for the trigger-mode-editing item and the behavior-mode-editing item is detected, the corresponding candidate applying modes may be displayed on the effect editing interface according to the trigger order of the two editing items.

In a specific implementation, when a click operation for the apply-mode-editing item which is inputted by the user through the input device or the touch point is detected, or it is detected that a duration when the user pauses, through the input device or the touch point, on the apply-mode-editing item reaches a preset duration, it is determined that the mode display triggering operation for the apply-mode-editing item is detected, the element attribute information of the element to be edited corresponding to the apply-mode-editing item triggered by the user is determined by responding to the triggering operation, so that at least one candidate applying mode corresponding to the element to be edited is determined according to the element attribute information and displayed on the effect editing interface. In the above implementation, the element attribute information may include the number of elements and/or the type of the effect.

Optionally, displaying the at least one candidate applying mode corresponding to the element to be edited includes: based on at least one selected from a group comprising a total number of at least one element to be edited and at least one effect type corresponding to each of the at least one element to be edited, determining the at least one candidate applying mode corresponding to the element to be edited from preset applying modes corresponding to at least one effect type corresponding to the element to be edited, and displaying the at least one candidate applying mode.

In the embodiment, the effect type may include a sticker effect, a make-up effect, a filter effect, a deformation effect, a liquefaction effect, a facial effect, a hairstyle effect, etc. The preset applying mode may be an applying mode, which is set in advance, of the effect element being applied to the image. The preset applying mode corresponds to the effect type of the effect element.

In practical application, the effect types of the effect elements may be determined in advance, and the applying modes corresponding to various effect types are respectively set to obtain preset applying modes corresponding to the various effect types, and the preset applying modes are stored in the database of the terminal device, and furthermore, upon determining the element to be edited and upon detecting a mode display triggering operation of the apply-mode-editing item corresponding to the element to be edited, the total number of the elements to be edited can be determined, the effect type corresponding to each element to be edited can be determined, the preset applying modes corresponding to the effect types are invoked, according to each of the effect types, respectively from the preset applying modes pre-stored in the database, these preset applying modes are taken as candidate applying modes corresponding to the element to be edited, and the candidate applying modes are displayed in the effect editing interface. Such setting has the advantage of increasing the efficiency of determining the candidate applying modes and, in turn, improving the efficiency of editing the effect elements.

In the present embodiment, when the candidate applying mode corresponding to the element to be edited is determined based on the total number of elements to be edited and/or the effect type corresponding to each element to be edited, different methods for determining the candidate applying mode may respectively correspond to the cases where the total number of elements to be edited is different, or the effect types corresponding to respective elements to be edited are different. Explanations on a plurality of cases that may exist and the method, corresponding to each case, for determining the candidate applying mode are provided in detail hereinafter.

The first case may be that: in a case that the total number of the element(s) to be edited is one, at least one effect type corresponding to the element to be edited is determined, and at least one preset applying mode corresponding to the at least one effect type is determined as the at least one candidate applying mode corresponding to the element to be edited.

In practical application, when the mode display triggering operation for the apply-mode-editing item corresponding to the element to be edited is detected, the total number of the elements to be edited and the effect type of the effect element may be detected, if the total number of the elements to be edited is detected as one, the effect type corresponding to the element to be edited may be determined. Furthermore, the preset applying mode corresponding to the effect type may be invoked according to the effect type from the preset applying modes corresponding to respective effect types stored in the database in advance, so that the invoked preset applying mode may be used as a candidate applying mode corresponding to the element to be edited and displayed on the effect editing interface.

The second case may be that: in a case that the total number of the elements to be edited is two or more and effect types corresponding to the element to be edited are the same, the preset applying mode corresponding to each of the effect types corresponding to the element to be edited is determined as the candidate applying mode corresponding to the element to be edited.

In practical application, when the mode display triggering operation for the apply-mode-editing item corresponding to the element to be edited is detected, the total number of the elements to be edited and the effect types of the effect elements may be detected, if it is detected that the total number of the elements to be edited is two or more and the effect types corresponding to the effect elements are the same, the preset applying mode corresponding to the effect type may be invoked according to the effect type from the preset applying modes corresponding to respective effect types stored in the database in advance, and further, the invoked preset applying mode may be used as a candidate applying mode corresponding to the element to be edited, and displayed on the effect editing interface.

The third case may be that: in a case that the effect types corresponding to the element to be edited are two or more, a preset applying mode that is common among all the preset applying modes corresponding to all the effect types is determined as a candidate applying mode corresponding to the element to be edited.

In practical application, when the mode display triggering operation for the apply-mode-editing item corresponding to the element to be edited is detected, the total number of the elements to be edited and the effect types corresponding to the effect elements may be detected, if it is detected that the total type number of the effect types corresponding to the elements to be edited are two or more, the preset applying modes corresponding to these kinds of effect types may be determined among the preset applying modes, stored in advance, corresponding to the respective effect types, and further, the preset applying modes that exist in common among the preset applying modes corresponding to the respective effect types may be determined from the determined preset applying modes corresponding to all of the effect types. In other words, the intersection between the preset applying mode sets respectively corresponding to the effect types is determined, the preset applying mode set corresponding to the effect type comprises at least one preset applying mode corresponding to the effect type, the preset applying modes included in the determined intersection set exist in the preset applying modes corresponding to each element to be edited, and further, the determined preset applying modes can be used as candidate applying modes corresponding to the element to be edited and displayed on the effect editing interface.

The fourth case may be that: in a case that the total number of the elements to be edited is two or more, the preset multi-element combination applying mode is determined as the candidate applying mode corresponding to the element to be edited.

In the embodiment, the multi-element combination applying mode may be an applying mode that is set in advance and in which a plurality of effect elements are combined to apply to the mage. The multi-element combination applying mode is associated with the display order and/or switching mode of each effect element. The display order may be an effect display order of the effect elements in the image. For example, the display order may be associated with the selection order of the elements to be edited. Specifically, when responding to the identification selection triggering operation for the element identifier, the selected order of the element identifiers may be determined if there are a plurality of selected element identifiers, and then the selected order may be taken as the display order of these elements to be edited. The switching mode may be a mode in which a plurality of effect elements are switched for display in an image. For example, the switching mode may include switching one by one based on the trigger mode and the display order, randomly stopping at any of the effect elements based on the trigger mode, randomly appearing any of the effect elements based on the trigger mode, or auto-play switching, among others. It should be noted that there may be one or more preset multi-element combination applying modes.

In practical application, the multi-element combination applying mode may be presct and stored in the database of the terminal device for a case where the total number of the elements to be edited is two or more. When the mode display triggering operation for the apply-mode-editing item corresponding to the element to be edited is detected, and it is determined that the total number of the elements to be edited is two or more, the multi-element combination applying mode may be invoked from the database, taken as a candidate applying mode corresponding to the element to be edited, and displayed on the effect editing interface.

S240, in response to a mode selection triggering operation for a candidate applying mode, taking the candidate applying mode selected as the target applying mode for the element to be edited to be applied to the effect processing image.

In the embodiment, the candidate applying mode may be set to be in a selectable state in advance, and further, in the case where the candidate applying mode is the selected candidate applying mode (that is, the candidate applying mode selected in the step S240), the candidate applying mode is taken as the target applying mode. The target applying mode may include a target trigger mode and a target behavior mode.

In practical application, the mode selection triggering operation for the candidate applying mode may be any operation acting on the candidate applying mode, for example, a click operation on the candidate applying mode. Here, the click operation may be a single click operation or a multi-click operation (e.g., a double-click operation, etc.). In order to facilitate the user's operation, the mode selection triggering operation for the candidate applying mode may also be that: when it is detected that the duration of the user's pause on the candidate applying mode based on the input device or the touch point reaches a preset duration, the candidate applying mode may be used as the target applying mode for the element to be edited to be applied to the effect processing image.

It should be noted that the apply-mode-editing item includes a behavior-mode-editing item and/or a trigger-mode-editing item, and accordingly, the candidate applying mode may include a candidate behavior mode and/or a candidate trigger mode.

In a specific implementation, if the apply-mode-editing item triggered by the user is a trigger-mode-editing item, at least one candidate trigger mode may be displayed in the effect editing interface, from which the user can select by a triggering operation. When the mode selection triggering operation for any candidate trigger mode by the user is detected, the selected candidate trigger mode may be taken as the target trigger mode corresponding to the element to be edited. If the apply-mode-editing item triggered by the user is a behavior-mode-editing item, at least one candidate behavior mode may be displayed in the effect editing interface, from which the user can select by a triggering operation. When the mode selection triggering operation for any of the candidate behavior modes by the user is detected, the selected candidate behavior mode may be taken as the target behavior mode corresponding to the element to be edited.

It needs to be explained that, for the elements to be edited that are determined at the same time, the target applying modes corresponding to the elements to be edited include target trigger modes and target behavior modes. Therefore, after determining the target trigger mode (or the target behavior mode) corresponding to the element to be edited, it may be detected whether the target behavior mode (or the target trigger mode) corresponding to the element to be edited have been determined. If not, the effect editing interface may be converted into an editing interface corresponding to a behavior-mode-editing item (or a trigger-mode-editing item) upon determining the target trigger mode (or the target behavior mode) corresponding to the element to be edited, and a candidate behavior mode (or candidate trigger mode) corresponding to the element to be edited is displayed in the editing interface.

The technical solution of the embodiment of the present disclosure, by displaying an effect editing interface in response to an interface display triggering operation for an effect processing image and displaying, in the effect editing interface, an element identifier of an effect element that has been added in the effect processing image, and then, in response to an identification selection triggering operation for the element identifier, taking an effect element corresponding to a selected element identifier as an element to be edited, and further in response to a mode display triggering operation for an apply-mode-editing item, displaying at least one candidate applying mode corresponding to the element to be edited, and finally, in response to a mode selection triggering operation for a candidate applying mode, using the candidate applying mode selected as the target applying mode of the element to be edited acting on the effect processing image, solves the problem in the prior art that the user cannot modify the editing parameters encapsulated in the software development tool kit, which leads to a relatively single effect display effect of the effect image or the effect video produced based on the effect prop and cannot satisfy the user's personalized editing needs for the effect prop. The technical solution of the present disclosure achieves the effect of determining the target applying mode from the candidate applying modes corresponding to the effect element, improves the editing efficiency of the target applying mode, and at the same time, satisfies the user's personalized editing needs for the effect element, and improves the user's experience in using the effect production tool.

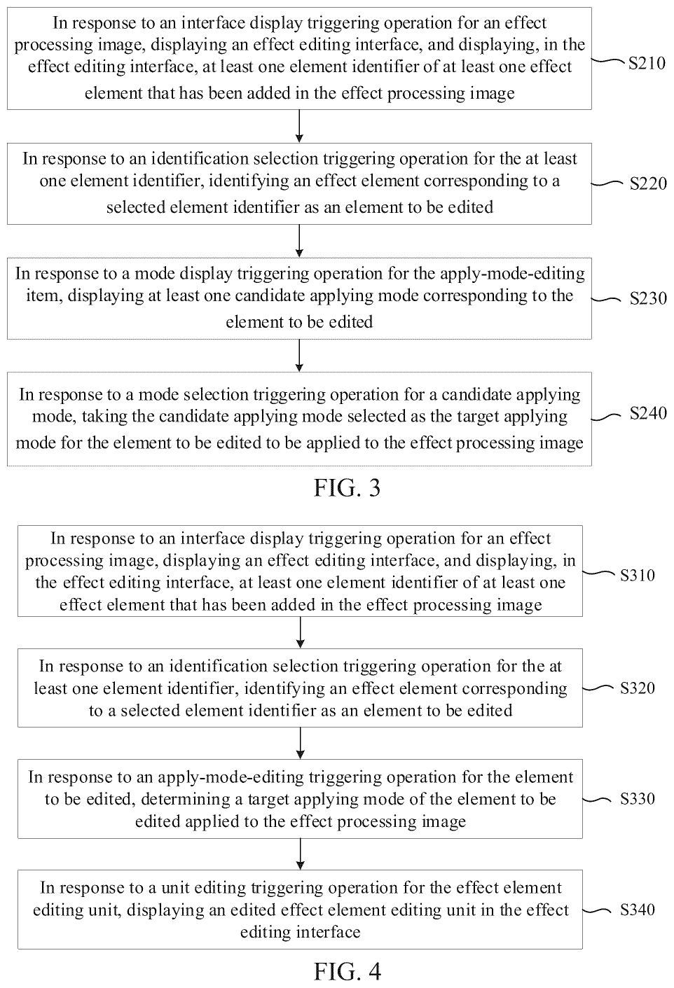

FIG. 4 is a schematic flowchart of another effect editing method according to an embodiment of the present disclosure. On the basis of the above embodiments, in technical solution of the present embodiment, the effect editing interface includes at least one effect element editing unit, the effect element editing unit includes at least one effect editing item, and the edited effect element editing unit may be displayed in the effect editing interface by responding to a unit editing triggering operation for the effect element editing unit. For specific implementation details, reference may be made to the description of the present embodiment. In the description, the technical features that are the same or similar to those in the foregoing embodiments are not repeated herein.

As shown in FIG. 4, the method of the present embodiment specifically may include the following steps:

S310, in response to an interface display triggering operation for an effect processing image, displaying an effect editing interface, and displaying, in the effect editing interface, at least one element identifier of at least one effect element that has been added in the effect processing image.

S320, in response to an identification selection triggering operation for the at least one element identifier, identifying an effect element corresponding to a selected element identifier as an element to be edited.

S330, in response to an apply-mode-editing triggering operation for the element to be edited, determining a target applying mode of the element to be edited applied to the effect processing image.

S340, in response to a unit editing triggering operation for the effect element editing unit, displaying an edited effect element editing unit in the effect editing interface.

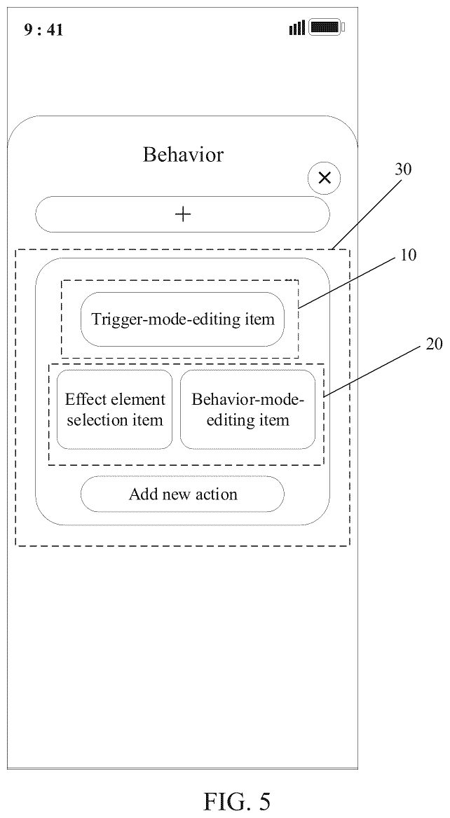

In the present embodiment, the effect element editing unit may be an editing collection including at least one effect editing item. The effect editing item is an information item that the effect element editing unit can edit by an interactive operation. The effect editing item may be an editing control for editing the effect element that has been added in the effect processing image. Alternatively, the effect editing items may include an effect element selection item, a behavior-mode-editing item, a trigger-mode-editing item, and the like. It should be noted that the effect editing items included in the effect element editing unit may be one or more. Exemplary, referring to FIG. 5, a dashed box 10 may be a first effect element editing unit, the number of effect editing item(s) included in the first effect element editing unit is one, that is, a trigger-mode-editing item; a dashed box 20 may be a second effect element editing unit, the number of effect editing items included in the second effect element editing unit may be two, and the effect editing items included in the second effect element editing unit are an effect element selection item and a behavior-mode-editing item, respectively; a dashed box 30 may be a third effect element editing unit, the number of effect editing items included in the third effect element editing unit is three, and the effect editing items included in the third effect element editing unit are a trigger-mode-editing item, an effect element selection item, and a behavior-mode-editing item, respectively.

The unit editing triggering operation includes a unit addition triggering operation for adding a new effect element editing unit, and the unit editing triggering operation further includes a unit deletion triggering operation for deleting an effect element editing unit that has been added. In the present embodiment, a unit addition trigger control may be developed in advance, when the triggering operation by the user on the unit addition trigger control is detected, the newly added effect element editing unit may be displayed in the effect editing interface; meanwhile, a unit deletion trigger control may also be developed in advance, when the triggering operation by the user on the unit deletion trigger control is detected, the corresponding added effect element editing unit can be deleted from the effect editing interface.

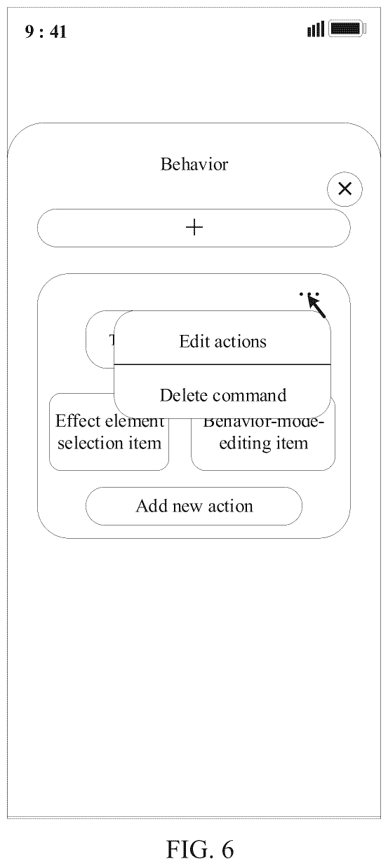

In practical application, if the effect element editing unit does not include all effect editing items, the effect element editing unit may be taken as an effect element editing sub-unit. For convenience of user operation, different unit addition trigger controls and unit deletion trigger controls may be developed for the effect element editing unit and the effect element editing sub-unit, respectively. Illustratively, as shown in FIG. 6, a unit addition trigger control corresponding to the effect element editing sub-unit may be an “Add new action” control; a unit deletion trigger control corresponding to the effect element editing sub-unit may be an “Edit actions” control; a unit addition trigger control corresponding to the effect element editing unit may be a “+” control; a unit deletion trigger control corresponding to the effect element editing unit may be a “Delete command” control. With continued reference to FIG. 6, for the “Add new action” control and the “Delete command” control, when the mouse cursor is moved to a “ . . . ” control and a click operation is entered into the “ . . . ” control, a detail interface is expanded below the “ . . . ” control, and the detail interface includes the “Add new action” control and the “Delete command” control.

In an implementation, if a unit addition triggering operation for an effect element editing sub-unit is detected, the newly added effect element editing sub-unit may be displayed in the effect editing interface; if a unit deletion triggering operation for the effect element editing sub-unit is detected, the added effect element editing sub-unit may be deleted from the effect editing interface.

In the actual application process, if only one effect editing item is included in the effect element editing unit, when an editing completion triggering operation for the effect editing item is detected, it may be determined that the editing operation for the effect element editing unit is completed; if two or more effect editing items are included in the effect element editing unit, after it is determined that the editing of one effect editing item is completed, the editing operation of another effect editing item may be performed directly.

Based on this, on the basis of each of the above technical solutions, the effect editing method further comprises: in a case that the effect element editing unit comprises two or more effect editing items, performing an editing start triggering operation for a next effect editing item in response to an editing completion triggering operation for an effect editing item currently edited.

In the present embodiment, for an effect editing item that can be selected only single, the selection completion operation can be determined as the editing completion triggering operation for the effect editing item; for an effect editing item that can be selected in a plurality of times, an editing completion trigger control can be developed in advance, and when a triggering operation to the editing completion trigger control is detected, it can be determined that the editing completion triggering operation to the effect editing item is detected. Exemplarily, if the effect editing item is a trigger-mode-editing item, when the selection triggering operation for any candidate trigger mode is detected, it can be determined that the editing of the trigger-mode-editing item is completed, and the selected target trigger mode is displayed in a display region corresponding to the trigger-mode-editing item; if the effect editing item is a behavior-mode-editing item, upon detecting a selection triggering operation for any candidate behavior mode, it is determined that the editing of the behavior-mode-editing item is completed, and the selected target behavior mode is displayed in a display region corresponding to the behavior-mode-editing item; if the effect editing item is an effect element selection item, the triggering operation may be input for an editing completion trigger control displayed in the effect editing interface after inputting the identification selection triggering operation for at least one element identifier, and when the triggering operation for the control is detected, it may be determined that the editing of the effect element selection item is completed and the selected element identifier is displayed in a display region corresponding to the effect element selection item.

In practical application, if the effect element editing unit comprises two or more effect editing items, the triggering operation may be responded to when the editing completion triggering operation for the effect editing item currently edited is detected, and further, the editing start triggering operation of the next effect editing item may be performed by jumping from the editing interface corresponding to the currently edited effect editing item to the editing interface corresponding to the next effect editing item included in the effect element editing unit. The advantage of such setting is that: the linkage interaction of the effect editing items can be achieved, thus improving the efficiency of the effect editing, and that the editing interface corresponding to the effect editing item can be displayed in a limited interface space, thus making full use of the interface space.

It should be noted that in the case that two or more effect editing items are included in the effect element editing unit, if the effect editing items included in the effect element editing unit are edited according to a preset editing order, the editing start triggering operation of the next effect editing item may be performed in response to the editing completion triggering operation of the currently edited effect editing item; if the effect editing items included in the effect element editing unit are not edited according to the preset editing order, it may be detected whether an unedited effect editing item is present in the effect element editing unit when the editing completion triggering operation of the currently edited effect editing item is detected, if the unedited effect editing item is present, the editing start triggering operation on the unedited effect editing item may be performed, and if there is no unedited effect editing item, it can stay in the editing interface corresponding to the currently edited effect editing item.

The technical solution of the embodiment of the present disclosure, by displaying an effect editing interface in response to an interface display triggering operation for an effect processing image, and displaying, in the effect editing interface, an element identifier of an effect element that has been added in the effect processing image, and then, in response to an identification selection triggering operation for the element identifier, identifying an effect element corresponding to a selected element identifier as an element to be edited, then, in response to an apply-mode-editing triggering operation for the element to be edited, determining a target applying mode for the element to be edited to be applied to the effect processing image, and further, in response to a unit editing triggering operation for the effect element editing unit, displaying the edited effect element editing unit in the effect editing interface, solves the problem in the prior art that the user cannot modify the editing parameters encapsulated in the software development tool kit, which leads to a relatively single effect display effect of the effect image or the effect video produced based on the effect prop and cannot satisfy the user's personalized editing needs for the effect prop, achieves the effect of personalized editing of the effect element editing unit, achieves the effect of overall editing of the effect editing items included in the effect element editing unit, enhances the intelligence of the effect production tool, improves the effect editing efficiency, and improves the use experience of the user.

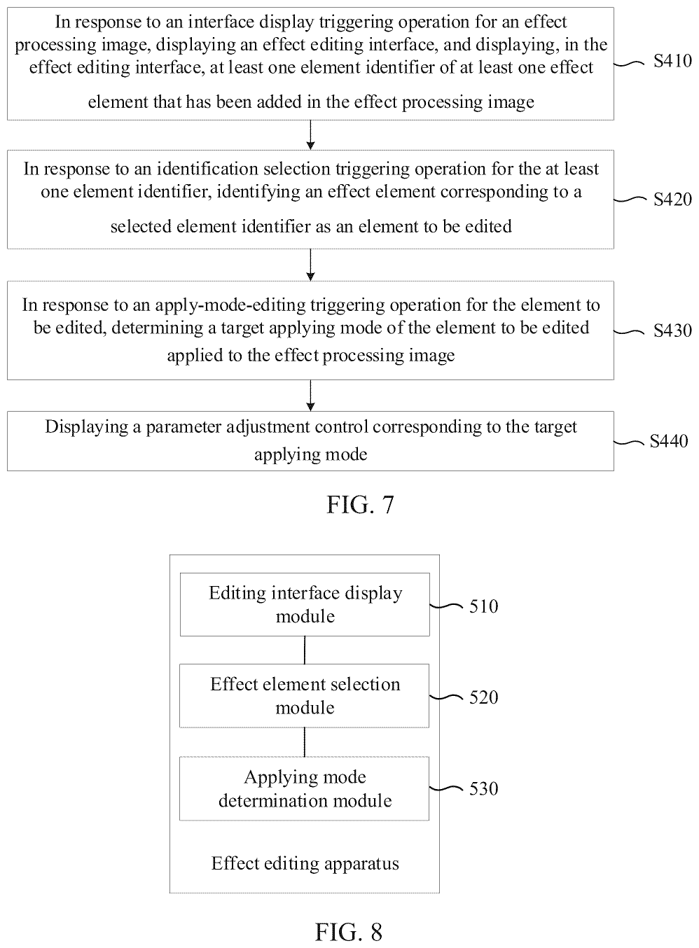

FIG. 7 is a schematic flowchart of another effect editing method according to an embodiment of the present disclosure. On the basis of the above embodiments, the technical solution of the present embodiment can display a parameter adjustment control corresponding to the target applying mode. For the specific implementation, reference may be made to the description of the present embodiment. In the description, the technical features that are the same or similar to those in the foregoing embodiments are not repeated herein.

As shown in FIG. 7, the method of the present embodiment specifically may include the following steps:

S410, in response to an interface display triggering operation for an effect processing image, displaying an effect editing interface, and displaying, in the effect editing interface, at least one element identifier of at least one effect element that has been added in the effect processing image.

S420, in response to an identification selection triggering operation for the at least one element identifier, identifying an effect element corresponding to a selected element identifier as an element to be edited.

S430, in response to an apply-mode-editing triggering operation for the element to be edited, determining a target applying mode of the element to be edited applied to the effect processing image.

S440, displaying a parameter adjustment control corresponding to the target applying mode.

In the present embodiment, the parameter adjustment control may be a control for adjusting or editing an applying parameter corresponding to the target applying mode. The parameter adjustment control may be any form of control, optionally, may be an adjustment axis control, a parameter input control, or the like. The parameter adjustment control may include an applying duration adjustment control, an applying intensity adjustment control, an applying frequency adjustment control, and the like.

In practical application, after the target applying mode corresponding to the element to be edited is determined, an editable applying parameter corresponding to the target applying mode can be determined, and a parameter adjustment control corresponding to the editable applying parameter is displayed on the effect editing interface, and further, the user can determine the target action parameter corresponding to the target applying mode by editing the parameter adjustment control, so that when the element to be edited is applied to the effect processing image based on the target applying mode, the element to be edited can be applied according to the target action parameter.

Based on this, after displaying the parameter adjustment control corresponding to the target applying mode, the effect editing method further includes: in response to a control triggering operation acting on the parameter adjustment control, determining a target action parameter adopted when applying the element to be edited to the effect processing image based on the target applying mode.

In the embodiment, when the parameter adjustment control is displayed on the effect editing interface, the action parameter corresponding to the parameter adjustment control may be a default action parameter set in advance, or the action parameter corresponding to the parameter adjustment control may be in a blank state.

In the embodiment, the control triggering operation acting on the parameter adjustment control may correspond to the control form of the parameter adjustment control. Illustratively, if the parameter adjustment control is an adjustment axis control, the control triggering operation may be to control the touch point to slide on the adjustment axis based on the input device and take the parameter corresponding to the point where the touch point stays on the adjustment axis as the target action parameter corresponding to the parameter adjustment control; if the parameter adjustment control is a parameter input control, the control triggering operation may be based on the input device inputting a corresponding action parameter in the parameter input region corresponding to the parameter adjustment control, and determining the inputted action parameter as the target action parameter corresponding to the parameter adjustment control.

In the actual application process, after the parameter adjustment control corresponding to the target applying mode is displayed in the effect editing interface, the control triggering operation can be inputted for the parameter adjustment control, when the control triggering operation acting on the parameter adjustment control is detected, the action parameter corresponding to the control triggering operation is determined in response to the control triggering operation, and the action parameter is taken as the target action parameter adopted when the element to be edited is applied to the effect processing image based on the target applying mode. The advantage of such setting is that: the effect of personalized editing of the action parameter of the target applying mode is achieved, the personalization adaptability between the effect edited by the user and the user is enhanced, the intelligence and diversity of the applying mode editing function of the effect element are enhanced, and the use experience of the user is improved.

The technical solution of the embodiment of the present disclosure, by displaying an effect editing interface in response to an interface display triggering operation for an effect processing image, and displaying, in the effect editing interface, an element identifier of an effect element that has been added in the effect processing image, and then, in response to an identification selection triggering operation for the element identifier, taking an effect element corresponding to a selected element identifier as an element to be edited, and then, in response to an apply-mode-editing triggering operation for the element to be edited, determining a target applying mode for the element to be edited to be applied to the effect processing image, and further, displaying a parameter adjustment control corresponding to the target applying mode, solves the problem in the prior art that the user cannot modify the editing parameters encapsulated in the software development tool kit, which leads to a relatively single effect display effect of the effect image or the effect video produced based on the effect prop and cannot satisfy the user's personalized editing needs for the effect prop, achieves the effect of personalized editing of the action parameter of the target applying mode, enhances the personalization adaptability between the effect edited by the user and the user, enhances the intelligence and diversity of the applying mode editing function of the effect element, and improves the use experience of the user.

FIG. 8 is a structural schematic diagram of an effect editing apparatus according to an embodiment of the present disclosure, as shown in FIG. 8, and the apparatus includes an editing interface display module 510, an effect element selection module 520, and an applying mode determination module 530.

The editing interface display module 510 is configured to, in response to an interface display triggering operation for an effect processing image, display an effect editing interface, and display, in the effect editing interface, at least one element identifier of at least one effect element that has been added in the effect processing image.

The effect element selection module 520 is configured to, in response to an identification selection triggering operation for the at least one element identifier, identify an effect element corresponding to a selected element identifier as an element to be edited.

The applying mode determination module 530 is configured to determine a target applying mode that the element to be edited is applied to the effect processing image in response to an apply-mode-editing triggering operation for the element to be edited.

On the basis of each of the above technical solutions, the effect editing interface is presented with an effect element selection item.

The editing interface display module 510 is specifically configured to display, in the effect editing interface, the at least one element identifier of the at least one effect element that has been added in the effect processing image in response to an element selection triggering operation acting on the effect element selection item.

On the basis of the above technical solutions, the effect editing interface further comprises an apply-mode-editing item corresponding to the element to be edited.

The applying mode determination module 530 includes: a candidate applying mode display unit and an applying mode determination unit.

The candidate applying mode display unit is configured to display at least one candidate applying mode corresponding to the element to be edited in response to a mode display triggering operation for the apply-mode-editing item.

The applying mode determination unit is configured to, in response to a mode selection triggering operation for a candidate applying mode, take the candidate applying mode selected as the target applying mode for the element to be edited to be applied to the effect processing image.

On the basis of the above technical solutions, the candidate applying mode display unit is specifically configured to determine the at least one candidate applying mode corresponding to the element to be edited from preset applying modes corresponding to at least one effect type corresponding to the element to be edited, and display the at least one candidate applying mode based on at least one selected from a group comprising a total number of at least one element to be edited and at least one effect type corresponding to each of the at least one element to be edited.

On the basis of the above technical solutions, the candidate applying mode display unit is specifically configured to perform at least one of the following operations:
in response to the total number of the at least one element to be edited being one, determining the at least one effect type corresponding to the element to be edited, and determining a preset applying mode corresponding to the effect type as a candidate applying mode corresponding to the element to be edited;
in response to the total number of the at least one element to be edited being two or more and effect types corresponding to the element to be edited being same, determining a preset applying mode corresponding to each of the effect types corresponding to the element to be edited as a candidate applying mode corresponding to the element to be edited;
in response to effect types corresponding to the element to be edited being two or more, determining a preset applying mode common to preset applying modes corresponding to all effect types as a candidate applying mode corresponding to the element to be edited; and
in response to the total number of the at least one element to be edited being two or more, determining a multi-element combination applying mode, which is preset, as a candidate applying mode corresponding to the element to be edited, the multi-element combination applying mode being associated with a display order and/or a switching mode of each effect element.

On the basis of each of the above technical solutions, the apply-mode-editing item includes a behavior-mode-editing item, and the behavior-mode-editing item is used for editing a target behavior mode of the element to be edited displayed on the effect processing image.

On the basis of each of the above technical solutions, the apply-mode-editing item further includes a trigger-mode-editing item, and the trigger-mode-editing item is used for editing a target trigger mode of the element to be edited displayed on the effect processing image.

On the basis of each of the above technical solutions, the effect editing interface includes at least one effect element editing unit, and the effect element editing unit includes at least one effect editing item.

The apparatus further comprises a unit editing module.

The unit editing module is configured to display an edited effect element editing unit in the effect editing interface in response to a unit editing triggering operation for the effect element editing unit. The unit editing triggering operation includes a unit addition triggering operation for adding a new effect element editing unit, and the unit editing triggering operation further includes a unit deletion triggering operation for deleting an effect element editing unit that has been added.

On the basis of the above technical solutions, the apparatus further comprises: an effect editing item editing execution module.

The effect editing item editing execution module is configured to perform an editing start triggering operation for a next effect editing item in response to an editing completion triggering operation for an effect editing item currently edited in a case that the effect element editing unit comprises two or more effect editing items. The effect editing item is an information item that the effect element editing unit can edit by an interactive operation.

On the basis of each of the above technical solutions, the target applying mode corresponding to a single element to be edited includes at least one selected from a group comprising: a dynamic display mode of an element display parameter of the effect element, an association mode of the effect element with respect to an image subject associated with the effect element in the effect processing image, and a behavior mode of the effect element.

On the basis of the above technical solutions, the apparatus further comprises: a parameter adjustment control display module.

The parameter adjustment control display module is configured to display a parameter adjustment control corresponding to the target applying mode after determining the target applying mode that the element to be edited is applied to the effect processing image.

On the basis of the above technical solutions, the apparatus further comprises: an action parameter determination module.

The action parameter determination module is configured to, after displaying the parameter adjustment control corresponding to the target applying mode, in response to a control triggering operation acting on the parameter adjustment control, determine a target action parameter used when applying the element to be edited to the effect processing image based on the target applying mode.

The technical solution of the embodiments of the present disclosure, by displaying an effect editing interface in response to an interface display triggering operation for an effect processing image, and displaying, in the effect editing interface, an element identifier of an effect element that has been added in the effect processing image, can accurately capture the user's editing intention for the effect element, display an editable effect element, and provide an interactive portal for the user; further, the technical solution of the embodiments of the present disclosure, by in response to an identification selection triggering operation for the element identifier, taking an effect element corresponding to a selected element identifier as an element to be edited, supports the flexible editing of the effect element by the user, supports diverse editing methods, and enriches the editing effect of the effect element, and finally, a target applying mode that the element to be edited is applied to the effect processing image is determined in response to an apply-mode-editing triggering operation for the element to be edited. The technical solution of the embodiments of the present disclosure solves the problem in the prior art that the user cannot modify the editing parameters encapsulated in the software development tool kit, and thus an effect display effect of the effect image or the effect video produced based on the effect prop is relatively simple, which cannot satisfy the user's personalized editing needs for the effect prop. The technical solution of the present disclosure achieves the effect that the user can customize and edit the mode of applying the effect element to the effect image, increases the flexibility of editing the effect element, and improves the user's experience in using the effect production tool.

The effect editing apparatus provided by the embodiments of the present disclosure may perform the effect editing method provided by any of the embodiments of the present disclosure, and has corresponding functional modules for performing the method and beneficial effects.

It is worth noting that the respective units and modules included in the above apparatus are divided only according to functional logic, but are not limited to the above division as long as the corresponding functions can be achieved; in addition, the specific names of the respective functional units are also merely for convenience of distinguishing from each other, and are not used to limit the protection scope of the embodiments of the present disclosure.

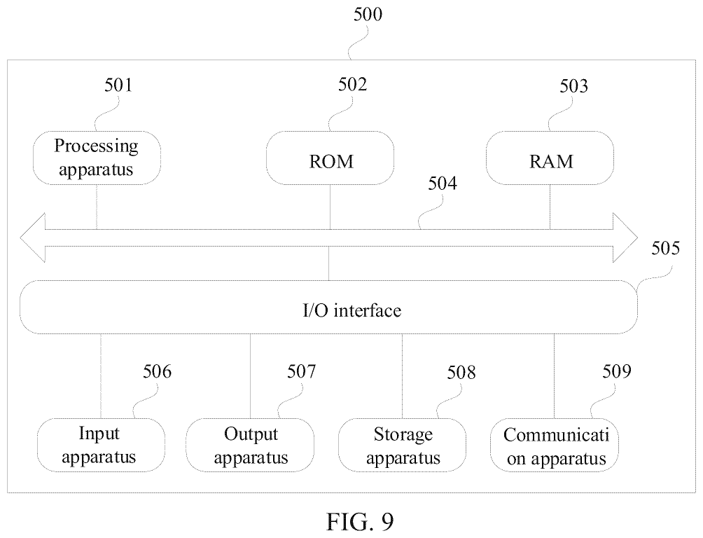

FIG. 9 is a structural schematic diagram of an electronic device according to an embodiment of the present disclosure. Reference is now made to FIG. 9, which shows a schematic structural diagram of an electronic device (e.g., a terminal device or a server in FIG. 9) 500 suitable for implementing embodiments of the present disclosure. The terminal device in the embodiment of the present disclosure may include, but is not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic device illustrated in FIG. 9 is merely one example and should not pose any limitation to the functions and the range of use of the embodiments of the present disclosure.

As shown in FIG. 9, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 9 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of messages or information interacted between a plurality of apparatuses in an implementation of the present disclosure are for illustrative purposes only and are not intended to limit the scope of such messages or information.

The electronic device provided by the embodiments of the present disclosure belongs to the same inventive concept as the effect editing method provided by the above embodiments, technical details that are not described in detail in the present embodiment can be found in the above embodiments, and the present embodiment has the same beneficial effects as the above embodiments.

An embodiment of the present disclosure provides a computer storage medium on which a computer program is stored, when the computer program is executed by a processor, the effect editing method provided by the above embodiments is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF), and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in response to an interface display triggering operation for an effect processing image, displaying an effect editing interface, and displaying, in the effect editing interface, at least one element identifier of at least one effect element that has been added in the effect processing image; in response to an identification selection triggering operation for the at least one element identifier, identifying an effect element corresponding to a selected element identifier as an element to be edited; and in response to an apply-mode-editing triggering operation for the element to be edited, determining a target applying mode that the element to be edited is applied to the effect processing image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes includes one or more executable instructions for implementing specified logical functions. It should also be noted that, in some alternative implementations, functions marked in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of a dedicated hardware and computer instructions.

The units involved in the embodiments of the present disclosure may be implemented by software, or may also be implemented by hardware. The name of a unit does not constitute a limitation on the unit itself. For example, a first acquisition unit may also be described as “a unit that acquires at least two Internet Protocol addresses”.

The functions described above in the present disclosure may be executed at least in part by one or more hardware logic components. For example, without limitations, exemplary types of the hardware logic components that can be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include but not be limited to an electronic, magnetic, optical, electromagnetic, infrared, or semi-conductive system, apparatus, or device, or any appropriate combination of them. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them.

[Example One] According to one or more embodiments of the present disclosure, an effect editing method is provided, and the method comprises:
in response to an interface display triggering operation for an effect processing image, displaying an effect editing interface, and displaying, in the effect editing interface, at least one element identifier of at least one effect element that has been added in the effect processing image;
in response to an identification selection triggering operation for the at least one element identifier, identifying an effect element corresponding to a selected element identifier as an element to be edited; and
in response to an apply-mode-editing triggering operation for the element to be edited, determining a target applying mode that the element to be edited is applied to the effect processing image.

[Example Two] According to one or more embodiments of the present disclosure, the method of Example One further comprises that:
optionally, the effect editing interface is presented with an effect element selection item; the displaying, in the effect editing interface, at least one element identifier of at least one effect element that has been added in the effect processing image comprises: displaying, in the effect editing interface, the at least one element identifier of the at least one effect element that has been added in the effect processing image in response to an element selection triggering operation acting on the effect element selection item.

[Example Three] According to one or more embodiments of the present disclosure, the method of Example One further comprises that:
optionally, the effect editing interface further comprises an apply-mode-editing item corresponding to the element to be edited; the in response to an apply-mode-editing triggering operation for the element to be edited, determining a target applying mode that the element to be edited is applied to the effect processing image, comprises:
in response to a mode display triggering operation for the apply-mode-editing item, displaying at least one candidate applying mode corresponding to the element to be edited; and
in response to a mode selection triggering operation for a candidate applying mode, taking the candidate applying mode selected as the target applying mode for the element to be edited to be applied to the effect processing image.

[Example Four] According to one or more embodiments of the present disclosure, the method of Example Three further comprises that:
optionally, the displaying at least one candidate applying mode corresponding to the element to be edited comprises:
based on at least one selected from a group comprising a total number of at least one element to be edited and at least one effect type corresponding to each of the at least one element to be edited, determining the at least one candidate applying mode corresponding to the element to be edited from preset applying modes corresponding to at least one effect type corresponding to the element to be edited, and displaying the at least one candidate applying mode.

[Example Five] According to one or more embodiments of the present disclosure, the method of Example Four further comprises that:
optionally, the based on at least one selected from a group comprising a total number of at least one element to be edited and at least one effect type corresponding to each of the at least one element to be edited, determining the at least one candidate applying mode corresponding to the element to be edited from preset applying modes corresponding to at least one effect type corresponding to the element to be edited comprises at least one of following operations:
in response to the total number of the at least one element to be edited being one, determining the at least one effect type corresponding to the element to be edited, and determining at least one preset applying mode corresponding to the at least one effect type as the at least one candidate applying mode corresponding to the element to be edited;
in response to the total number of the at least one element to be edited being two or more and effect types corresponding to the element to be edited being same, determining a preset applying mode corresponding to each of the effect types as a candidate applying mode corresponding to the element to be edited;
in response to effect types corresponding to the element to be edited being two or more, determining a preset applying mode common to preset applying modes corresponding to all effect types as a candidate applying mode corresponding to the element to be edited; and
in response to the total number of the at least one element to be edited being two or more, determining a multi-element combination applying mode, which is preset, as a candidate applying mode corresponding to the element to be edited, the multi-element combination applying mode being associated with a display order and/or a switching mode of each effect element.

[Example Six] According to one or more embodiments of the present disclosure, the method of Example Three further comprises that:
optionally, the apply-mode-editing item comprises a behavior-mode-editing item, and the behavior-mode-editing item is used for editing a target behavior mode of the element to be edited displayed in the effect processing image.

[Example Seven] According to one or more embodiments of the present disclosure, the method of Example Three further comprises that:
optionally, the apply-mode-editing item comprises a trigger-mode-editing item, and the trigger-mode-editing item is used for editing a target trigger mode of the element to be edited displayed in the effect processing image.

[Example Eight] According to one or more embodiments of the present disclosure, the method of Example One further comprises that:
optionally, the effect editing interface comprises at least one effect element editing unit, and an effect element editing unit comprises at least one effect editing item; and the method further comprises:
displaying an edited effect element editing unit in the effect editing interface in response to a unit editing triggering operation for the effect element editing unit, the unit editing triggering operation comprising a unit addition triggering operation for adding a new effect element editing unit, and the unit editing triggering operation further comprising a unit deletion triggering operation for deleting an effect element editing unit that has been added.

[Example Nine] According to one or more embodiments of the present disclosure, the method of Example Eight further comprises that: optionally, the method further comprises: in response to the effect element editing unit comprising two or more effect editing items, performing an editing start triggering operation for a next effect editing item in response to an editing completion triggering operation for an effect editing item currently edited, the effect editing item being an information item that can be edited by the effect element editing unit through an interactive operation.

[Example Ten] According to one or more embodiments of the present disclosure, the method of Example One further comprises that:
optionally, the target applying mode corresponding to a single element to be edited comprises at least one selected from a group comprising: a dynamic display mode of an element display parameter of the effect element, an association mode of the effect element with respect to an image subject associated with the effect element in the effect processing image, and a behavior mode of the effect element.

[Example Eleven] According to one or more embodiments of the present disclosure, the method of Example One further comprises that:
optionally, after the determining a target applying mode that the element to be edited is applied to the effect processing image, the method further comprises:
displaying a parameter adjustment control corresponding to the target applying mode.

[Example Twelve] According to one or more embodiments of the present disclosure, the method of Example Eleven further comprises that:
optionally, after the displaying a parameter adjustment control corresponding to the target applying mode, the method further comprises:
in response to a control triggering operation acting on the parameter adjustment control, determining a target action parameter adopted when applying the element to be edited to the effect processing image based on the target applying mode.

[Example Thirteen] According to one or more embodiments of the present disclosure, an effect editing apparatus is provided and the apparatus comprises:
an editing interface display module, configured to, in response to an interface display triggering operation for an effect processing image, display an effect editing interface, and display, in the effect editing interface, at least one element identifier of at least one effect element that has been added in the effect processing image;
an effect element selection module, configured to, in response to an identification selection triggering operation for the at least one element identifier, identify an effect element corresponding to a selected element identifier as an element to be edited; and
an applying mode determination module, configured to, in response to an apply-mode-editing triggering operation for the element to be edited, determine a target applying mode that the element to be edited is applied to the effect processing image.

The foregoing descriptions are merely the illustrations of the alternative embodiments of the present disclosure and the explanations of the technical principles involved. Those skilled in the art should understand that the scope of the disclosure involved in the present disclosure is not limited to the technical solutions formed by a specific combination of the technical features described above, and shall also cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated particular order or in a sequential order. Under certain circumstances, multitasking and parallel processing may be advantageous. Similarly, although some specific implementation details are included in the above discussions, these shall not be construed as limitations to the scope of the present disclosure. Some features described in the context of a separate embodiment may also be implemented in a combination in a single embodiment. Conversely, various features described in the context of a single embodiment may also be implemented in various embodiments individually or in any appropriate sub-combination.

Although the present subject matter has been described in a language specific to structural features and/or logical method acts, it will be appreciated that the subject matter defined in the appended claims is not necessarily limited to the particular features or acts described above. Rather, the particular features and acts described above are merely exemplary forms for implementing the claims.

1. An effect editing method, comprising:
in response to an interface display triggering operation for an effect processing image, displaying an effect editing interface, and displaying, in the effect editing interface, at least one element identifier of at least one effect element that has been added in the effect processing image;
in response to an identification selection triggering operation for the at least one element identifier, identifying an effect element corresponding to a selected element identifier as an element to be edited; and
in response to an apply-mode-editing triggering operation for the element to be edited, determining a target applying mode that the element to be edited is applied to the effect processing image.

2. The effect editing method according to claim 1, wherein the effect editing interface is presented with an effect element selection item;
the displaying, in the effect editing interface, at least one element identifier of at least one effect element that has been added in the effect processing image comprises:
displaying, in the effect editing interface, the at least one element identifier of the at least one effect element that has been added in the effect processing image in response to an element selection triggering operation acting on the effect element selection item.

3. The effect editing method according to claim 1, wherein the effect editing interface further comprises an apply-mode-editing item corresponding to the element to be edited;
the in response to an apply-mode-editing triggering operation for the element to be edited, determining a target applying mode that the element to be edited is applied to the effect processing image, comprises:
in response to a mode display triggering operation for the apply-mode-editing item, displaying at least one candidate applying mode corresponding to the element to be edited; and
in response to a mode selection triggering operation for a candidate applying mode, taking the candidate applying mode selected as the target applying mode for the element to be edited to be applied to the effect processing image.

4. The effect editing method according to claim 3, wherein the displaying at least one candidate applying mode corresponding to the element to be edited comprises:
based on at least one selected from a group comprising a total number of at least one element to be edited and at least one effect type corresponding to each of the at least one element to be edited, determining the at least one candidate applying mode corresponding to the element to be edited from preset applying modes corresponding to at least one effect type corresponding to the element to be edited, and displaying the at least one candidate applying mode.

5. The effect editing method according to claim 4, wherein the based on at least one selected from a group comprising a total number of at least one element to be edited and at least one effect type corresponding to each of the at least one element to be edited, determining the at least one candidate applying mode corresponding to the element to be edited from preset applying modes corresponding to at least one effect type corresponding to the element to be edited comprises at least one of following operations:
in response to the total number of the at least one element to be edited being one, determining the at least one effect type corresponding to the element to be edited, and determining at least one preset applying mode corresponding to the at least one effect type as the at least one candidate applying mode corresponding to the element to be edited;
in response to the total number of the at least one element to be edited being two or more and effect types corresponding to the element to be edited being same, determining a preset applying mode corresponding to each of the effect types as a candidate applying mode corresponding to the element to be edited;
in response to effect types corresponding to the element to be edited being two or more, determining a preset applying mode common to preset applying modes corresponding to all effect types as a candidate applying mode corresponding to the element to be edited; and
in response to the total number of the at least one element to be edited being two or more, determining a multi-element combination applying mode, which is preset, as a candidate applying mode corresponding to the element to be edited, wherein the multi-element combination applying mode is associated with a display order and/or a switching mode of each effect element.

6. The effect editing method according to claim 3, wherein the apply-mode-editing item comprises a behavior-mode-editing item, and the behavior-mode-editing item is used for editing a target behavior mode of the element to be edited displayed in the effect processing image.

7. The effect editing method according to claim 3, wherein the apply-mode-editing item comprises a trigger-mode-editing item, and the trigger-mode-editing item is used for editing a target trigger mode of the element to be edited displayed in the effect processing image.

8. The effect editing method according to claim 1, wherein the effect editing interface comprises at least one effect element editing unit, and an effect element editing unit comprises at least one effect editing item; and the method further comprises:
displaying an edited effect element editing unit in the effect editing interface in response to a unit editing triggering operation for the effect element editing unit,
wherein the unit editing triggering operation comprises a unit addition triggering operation for adding a new effect element editing unit, and the unit editing triggering operation further comprises a unit deletion triggering operation for deleting an effect element editing unit that has been added.

9. The effect editing method according to claim 8, further comprising:
in response to the effect element editing unit comprising two or more effect editing items, performing an editing start triggering operation for a next effect editing item in response to an editing completion triggering operation for an effect editing item currently edited, wherein the effect editing item is an information item that the effect element editing unit is capable of editing by an interactive operation.

10. The effect editing method according to claim 1, wherein the target applying mode corresponding to a single element to be edited comprises at least one selected from a group comprising: a dynamic display mode of an element display parameter of the effect element, an association mode of the effect element with respect to an image subject associated with the effect element in the effect processing image, and a behavior mode of the effect element.

11. The effect editing method according to claim 1, after the determining a target applying mode that the element to be edited is applied to the effect processing image, further comprising:
displaying a parameter adjustment control corresponding to the target applying mode.

12. The effect editing method according to claim 11, after the displaying a parameter adjustment control corresponding to the target applying mode, further comprising:
in response to a control triggering operation acting on the parameter adjustment control, determining a target action parameter adopted when applying the element to be edited to the effect processing image based on the target applying mode.

13. An effect editing apparatus, comprising:
an editing interface display module, configured to, in response to an interface display triggering operation for an effect processing image, display an effect editing interface, and display, in the effect editing interface, at least one element identifier of at least one effect element that has been added in the effect processing image;
an effect element selection module, configured to, in response to an identification selection triggering operation for the at least one element identifier, identify an effect element corresponding to a selected element identifier as an element to be edited; and
an applying mode determination module, configured to, in response to an apply-mode-editing triggering operation for the element to be edited, determine a target applying mode that the element to be edited is applied to the effect processing image.

14. The effect editing apparatus according to claim 13, wherein the effect editing interface is presented with an effect element selection item;
the editing interface display module is configured to display, in the effect editing interface, the at least one element identifier of the at least one effect element that has been added in the effect processing image in response to an element selection triggering operation acting on the effect element selection item.

15. The effect editing apparatus according to claim 13, wherein the effect editing interface further comprises an apply-mode-editing item corresponding to the element to be edited,
the applying mode determination module comprises a candidate applying mode display unit and an applying mode determination unit,
the candidate applying mode display unit is configured to display at least one candidate applying mode corresponding to the element to be edited in response to a mode display triggering operation for the apply-mode-editing item; and
the applying mode determination unit is configured to, in response to a mode selection triggering operation for a candidate applying mode, take the candidate applying mode selected as the target applying mode for the element to be edited to be applied to the effect processing image.

16. The effect editing apparatus according to claim 15, wherein the candidate applying mode display unit is configured to determine, based on at least one selected from a group comprising a total number of at least one element to be edited and at least one effect type corresponding to each of the at least one element to be edited, the at least one candidate applying mode corresponding to the element to be edited from preset applying modes corresponding to at least one effect type corresponding to the element to be edited, and display the at least one candidate applying mode.

17. The effect editing apparatus according to claim 16, wherein the candidate applying mode display unit is configured to perform at least one of following operations:
in response to the total number of the at least one element to be edited being one, determining the at least one effect type corresponding to the element to be edited, and determining at least one preset applying mode corresponding to the at least one effect type as the at least one candidate applying mode corresponding to the element to be edited;
in response to the total number of the at least one element to be edited being two or more and effect types corresponding to the element to be edited being same, determining a preset applying mode corresponding to each of the effect types as a candidate applying mode corresponding to the element to be edited;
in response to effect types corresponding to the element to be edited being two or more, determining a preset applying mode common to preset applying modes corresponding to all effect types as a candidate applying mode corresponding to the element to be edited; and
in response to the total number of the at least one element to be edited being two or more, determining a multi-element combination applying mode, which is preset, as a candidate applying mode corresponding to the element to be edited, wherein the multi-element combination applying mode is associated with a display order and/or a switching mode of each effect element.

18. The effect editing apparatus according to claim 13, further comprising a unit editing module,
wherein the effect editing interface comprises at least one effect element editing unit, and an effect element editing unit comprises at least one effect editing item;
the unit editing module is configured to display an edited effect element editing unit in the effect editing interface in response to a unit editing triggering operation for the effect element editing unit,
wherein the unit editing triggering operation comprises a unit addition triggering operation for adding a new effect element editing unit, and the unit editing triggering operation further comprises a unit deletion triggering operation for deleting an effect element editing unit that has been added.

19. An electronic device, comprising:
one or more processors;
a storage apparatus, for storing one or more programs,
wherein the one or more programs, when executed by the one or more processors, cause the one or more processors to implement an effect editing method,
the effect editing method comprises:
in response to an interface display triggering operation for an effect processing image, displaying an effect editing interface, and displaying, in the effect editing interface, at least one element identifier of at least one effect element that has been added in the effect processing image;
in response to an identification selection triggering operation for the at least one element identifier, identifying an effect element corresponding to a selected element identifier as an element to be edited; and
in response to an apply-mode-editing triggering operation for the element to be edited, determining a target applying mode that the element to be edited is applied to the effect processing image.

20. A non-transitory computer-readable storage medium comprising computer-executable instructions, wherein the computer-executable instructions, when executed by a computer processor, are used for performing the effect editing method according to claim 1.
